(19) United States
(12) Patent Application Publication
(10) Pub. No.: US 2005/0259608 A1
(43) Pub. Date: Nov. 24, 2005

(54) Wireless IP backbone using broadband RF technologies

(75) Inventor: Arturo Ortega, Leesburg, VA (US)

Correspondence Address: CROWELL & MORING LLP;INTELLECTUAL PROPERTY GROUP, P.O. BOX 14300, WASHINGTON, DC, 20044-4300, US

(73) Assignee: Nextel Communications, Inc.

(21) Appl. No.: 10/851,386

(22) Filed: May 21, 2004

(51) Int. Cl. H04B 7/216

(52) U.S. Cl. 370/328

(57) ABSTRACT

A wireless communications system is disclosed including a carrier network and a backbone for facilitating communications between the carrier network and subscriber units (SUs). The backbone includes one or more “wired” cell sites coupled to the carrier network by respective T1 communication line(s), and one or more “wireless” cell sites that receive communications from and transmit communications to the carrier network by way of the one or more “wired” cell sites. Such wireless communications system, that provides wireless cell-to-cell communications to relay communications, is able to provide wireless services to subscribers with reduced number of T1 communication lines connecting cell sites to the carrier network. Such a reduction in T1 communication lines allows a wireless carrier to substantially reduce its operating costs.

### FIELD OF THE INVENTION

This invention relates generally to communications systems, and in particular, to a communications system having a wireless internet protocol (IP) backbone using broadband radio frequency (RF) technologies to provide, which will be enabled to providing multiple paths between subscriber units and the carrier network. Accordingly, the invention relates to cell site configuration and operation and the carrier network.

### BACKGROUND OF THE INVENTION

Wireless communications in the form of cellular, dispatch, and data communications are becoming increasingly popular. Accordingly, an ever increasing number of people are subscribing to such wireless communications services. This need to service more subscribers has caused some problems for wireless carriers providing such services. The following example illustrates one such problem.

FIG. 1 illustrates a block diagram of a typical wireless communications system 100. The wireless communications system 100 consists of a carrier network 102, and a backbone including a plurality of cell sites 104a-f and a plurality of T1 communication lines T1-a-f respectively coupling the cell sites 104a-f to the carrier network 102. The wireless communications system 100 provides wireless services to a plurality of subscriber units (SUs), two of which are shown as SUs 106 and 108. The carrier network 102 may be coupled to a public switch telephone network (PSTN) 110 to allow subscribers to communicate with non-subscribers, one of which is shown as non-subscriber unit (NSU) 112.

In operation, the carrier network 102 establishes communication links between SUs. Accordingly, if SU 106 is communicating with SU 108, the communication is sent from SU 106 to cell cite 104b by way of a wireless medium. The cell site 104b, in turn, sends the communication to the carriers network 102 by way of communication line T1-b. The carriers network 102 performs intelligent routing to send the communication to cell site 104e by way of communication line T1-e. The cell site 104e then sends the communication to SU 108 by way of the wireless medium. If SU 106 is communicating with NSU 112, the communication routing process is similar except that the carrier network 102 routes the communication to NSU 112 by way of the PSTN 110.

As indicated above, the growing number of subscribers has placed strain on carrier's wireless communications system. For instance, as the number of subscribers grow, generally the more cells cites and T1 communication lines are required to serve them. Typically, a wireless carrier leases T1 lines through local wireline carriers, which could be very expensive. Therefore, as the number of subscribers and wireless communication-like services increase, the cost of leasing more T1 lines likewise increases to meet the demand for existing sites that offer these services. This significantly cuts into the profitability of wireless carriers.

### SUMMARY OF THE INVENTION

An aspect of the invention relates to a wireless communications system comprising a carrier network and a backbone for facilitating communications between the carriers network and subscriber units (SUs) by way of one or more cell sites. The backbone includes one or more “wired” cell sites coupled to the carrier network by respective T1 communication line(s), and one or more “wireless” cell sites that receive communications from and transmit communications to the carrier network by way of the one or more “wired” cell sites. The wireless communications system provides wireless cell-to-cell communications to relay communications between SUs and the carrier network. Such a wireless communications system is able to provide wireless services to subscribers with a reduced number of T1 communication lines connecting cell sites to the carrier network. Such a reduction in T1 communication lines allows a wireless carriers to substantially reduce its operating costs and possibly offer wireless communication services that have not been cost effective for cellular carriers due to the increase in costs associated with leasing additional T1s to offer those services.

Another aspect of the invention relates to a wireless communications system comprising a carrier network and a backbone for facilitating communications between the carrier network and subscriber units (SUs) by way of one or more cell sites. The backbone includes one or more “wired” cell sites coupled to the carriers network by respective T1 communication line(s), one or more “wireless” cell sites that receive communications from and transmit communications to the carrier network by way of a wireless medium, and one or more “fiber optic” cell sites that receive communications from and transmit communications to the carrier network by way of a fiber optic medium. The wireless communications system provides wireless cell-to-cell communications and fiber optic cell-to-cell communications to relay communications between SUs and the carrier network. Wireless carriers may take advantage of current fiber rings deployed in most metropolitan areas. Such a wireless communications system is able to provide wireless services to subscribers with a reduced number of T1 communication lines connecting cell sites to the carrier network. Such a reduction in T1 communication lines allows a carrier network to substantially reduce its operating costs and possibly offer wireless communication services that have not been cost effective for carriers due to the increase in costs associated with leasing additional T1s to offer those services.

Another aspect of the invention relates to a “wireless” cell site used in such wireless communications systems. The cell site comprises a radio frequency (RF) interface; a first converter to convert a communication in an RF protocol received from the RF interface to a routing protocol (e.g., an internet protocol); a routing module to determine routing information for the communication, and to modify the communication with the routing information; and a second converter to convert the modified communication from the routing protocol to the RF protocol, and send the modified communication in the RF protocol to the RF interface for transmission by way of the wireless medium through alternative paths, which may be based on the most effective route.

Other aspects, features, and techniques of the invention will be apparent to one skilled in the relevant art in view of the following detailed description of the invention.

### BRIEF DESCRIPTION OF THE DRAWINGS

FIG. 1 illustrates a block diagram of a typical wireless communications system;

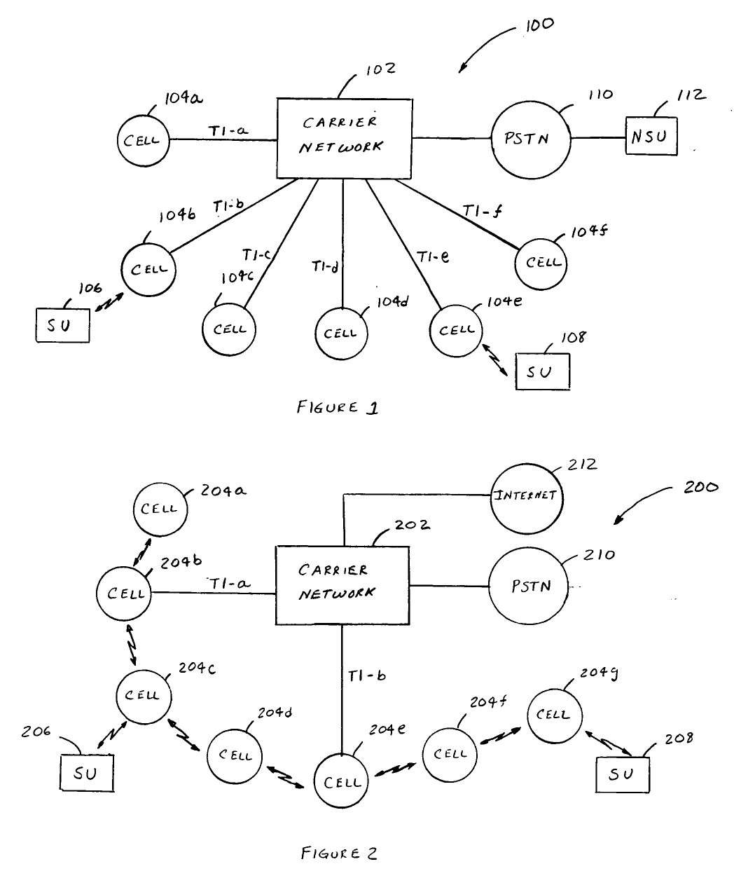

FIG. 2 illustrates a block diagram of an exemplary wireless communications system in accordance with an embodiment of the invention;

FIG. 3 illustrates a block diagram of an exemplary wireless communications system in accordance with another embodiment of the invention; and

FIG. 4A-4D illustrate block diagrams of exemplary cell sites in accordance with another embodiment of the invention.

### DETAILED DESCRIPTION OF THE INVENTION

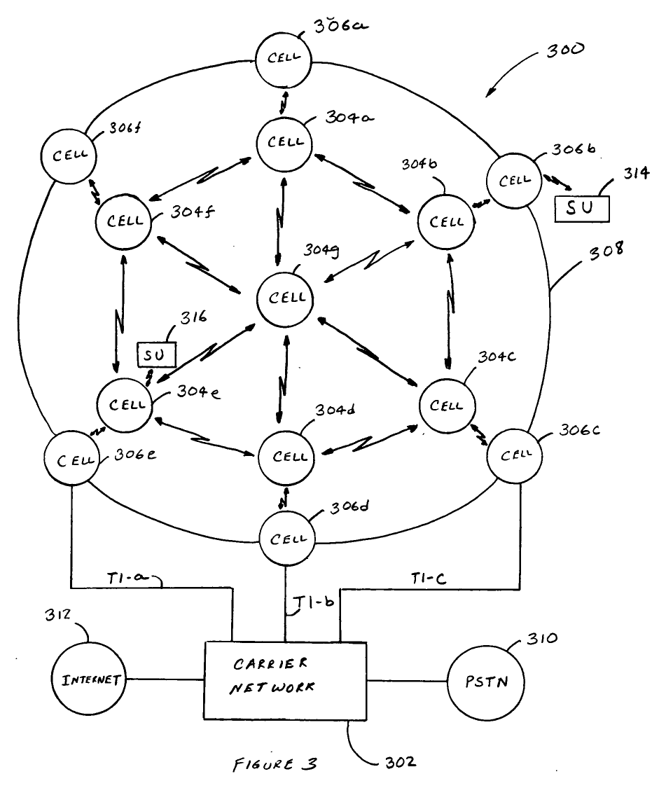

FIG. 2 illustrates a block diagram of an exemplary wireless communications system 200 in accordance with an embodiment of the invention. The wireless communications system 200 comprises a carrier network 202, and a backbone including a plurality of cell cites 204a-g, and one or more T1 communication lines, such as lines T1-a and T1-b, coupling at least one or a subset of the cell sites, such as cell sites 204b and 204e, to the carrier network 202. The wireless communications system 200 provides wireless services to a plurality of subscriber units (SU), two of which are shown as SUs 206 and 208. An SU may be a mobile unit, such as a cellular and/or dispatch telephone, a laptop computer, a personal digital assistant (PDA) device, a pager, and other portable devices. An SU may also be a generally stationary device, such as a personal computer or console.

The carrier network 202 may also be coupled to a public switch telephone network (PSTN) 210 to allow subscribers to communicate with non-subscribers over the PSTN 210. In addition, the carrier network 202 may be coupled to a packet switch network 212, such as the Internet, intranet, and/or local area network (LAN), to access websites and applications, and to also communicate with other subscriber and/or non-subscriber units. For example, such units accessible by way of the packet switch network 212 include a desktop device usable in a dispatch-to-desktop service.

The wireless communications system 200 departs from the prior wireless communications system 100 in that it includes a backbone that provides wireless cell-to-cell communications to relay communications between SUs and the carrier network 202. For instance, the wireless communications system 200 includes a plurality of wireless cell sites, such as cell sites 204a, 204c, 204d, 204f, and 204g. These wireless cell sites relay communications between neighboring cell sites, and between SUs and cell sites. The wireless communications system 200 further includes one or more cell sites, such as cell sites 204b and 204e, that are coupled to the carrier network 202 by way of T1 communication lines T1a-b. These cell sites 204b and 204e relay communications between SUs and the carrier network 202, between other cell sites and the carrier network 202, and between other cell sites.

The cell sites 204a-g of the wireless communications system 200 intelligently route communications from SUs to the carrier network 202, and vice-versa, possibly by way of more than one cell site. The cell sites 204a-g may route the communications based on a number of parameters, such as the intended destination, traffic congestion, load balancing, infrastructure failure, etc. In performing its routing algorithm, a cell site receives a radio frequency (RF) communication from an SU or another cell site using any of a number of different RF protocols, such as code division multiple access (CDMA), wideband code division multiple access (WCDMA), time division multiple access (TDMA), frequency division multiple access (FDMA), orthogonal frequency division multiplexing (OFDM), or others. The cell site converts the RF signal to a protocol useful for routing purposes, such as Internet Protocol (IP). Then the cell site performs a routing algorithm to determine where to send the communication, such as to another cell site, a target SU, and/or the carrier network. Once the destination is known, the cell site converts the communication from IP to RF, and transmits the communication to the other cell site, target SU, and/or the carrier network.

As an example, SU 206 desires to send a communication (such as data, cellular voice, and/or dispatch voice) to target SU 208. According to the example, SU 206 first sends the communication to a nearby cell site 204c compliant with an RF protocol by way of a wireless medium. The cell site 204c converts the RF communication to a routing protocol (e.g. IP). Then, assuming no traffic congestion, load balancing, infrastructure failure, or other problems that may affect routing, the cell site 204c determines that the communication is to be routed to cell site 204b. The cell site 204c then converts the communication in the routing protocol (e.g. IP) to the appropriate RF protocol, and transmits the RF communication to cell site 204b by way of the wireless medium.

Similarly, the cell site 204b also converts the RF communication to a routing protocol (e.g. IP), determines where to route the communication, and, in this example, sends the communication to the carrier network 202 by way of communication T1-a. The carrier network 202 then determines where to route the communication. In this example, the carrier network 202 sends the communication to cell site 204e by way of communication line T1-b. Similarly, the cell site 204e determines where to route the communication. In this example, the cell site 204e determines that the communication be routed to cell site 204f. The cell site 204e then converts it to RF protocol for transmission to cell site 204f by way of the wireless medium.

Once cell site 204f receives the RF communication, it converts the RF communication to a routing protocol (e.g. IP), determines that the communication is to be routed to cell site 204g, and converts it back again to the RF protocol for transmission to cell site 204g. Once cell site 204g receives the RF communications, it converts the RF communication to the routing protocol (e.g. IP), and determines that the communication be routed to SU 208. The cell site 204g converts the communication back to the RF protocol, and transmits the RF communication to SU 208 by way of the wireless medium, and locks a transmit and receive link to the original destination and vice versa. A communication from SU 208 back to SU 206 may take a similar path except in the opposite direction.

In the above example, it was assumed that the routing of the communication was not affected by network environment conditions, such as traffic congestion, load balancing, infrastructure failure, and/or other conditions. In the following example, it is assumed that there is a problem with cell site 204b (e.g. it is handling too much traffic or it has failed). In the same case that SU 206 desires to send a communication to SU 208, the communication routing process is similar to the one described above, except that it will take a different path. For instance, the communication may first go to cell site 204c, then to cell site 204d, then to cell site 204e, then to the carrier network 202, then back to cell site 204e, then to cell site 204f, then to cell site 204g, and finally to SU 208. In performing the routing function, neighbor cell sites provide each other information about their environment conditions, such as how much traffic they are currently handling, whether there are technical problems with the cell site that affect its routing capability, and/or other information useful for cell sites to make routing decisions.

An advantage of the wireless communications system 200 over the prior system 100 is that, because the system 200 includes a backbone that provides for direct cell-to-cell communications to route communications to intended destinations, the system 200 requires less T1 communication lines. For instance, the prior wireless communications system 100 has six (6) T1 lines, whereas the wireless communications system 200 has only two (2). The fact is that more T1s will be required in communication system 200, however, strategic cell sites may be selected to reduce the cost of leasing T1s by leasing them as bundled. In practical wireless communications system having thousands of cells sites, the methodology of providing direct cell-to-cell communications may reduce the number of T1 communication lines by thousands. As discussed in the Background section, leasing a T1 communication line may be expensive. Therefore, by substantially reducing the number of T1 communication lines required for a wireless communications system, a wireless carriers operating such system could lower its operating costs substantially.

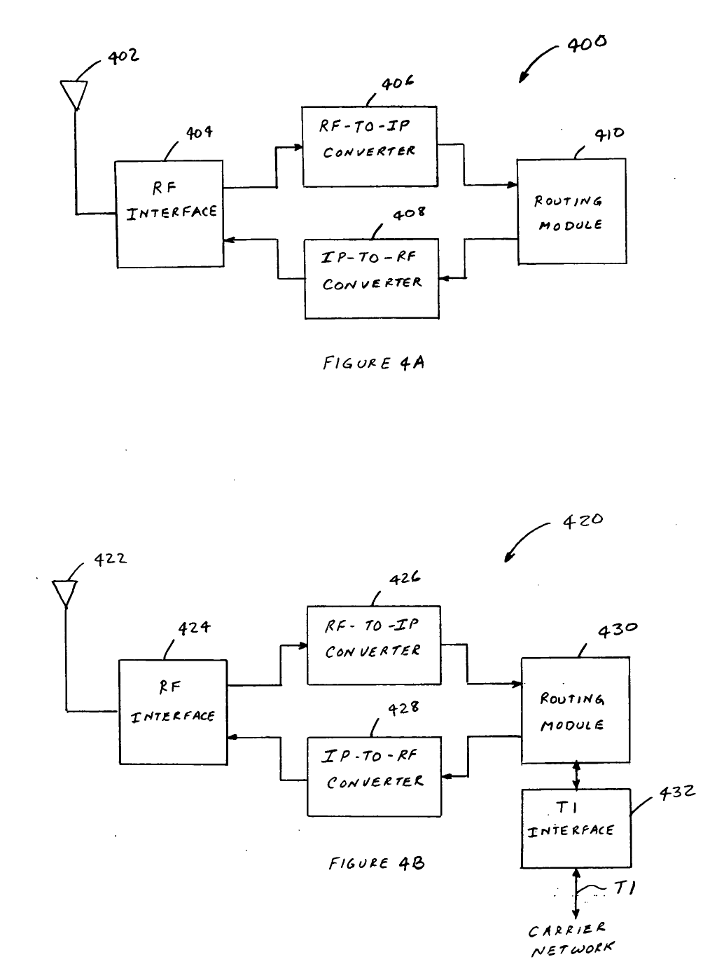

FIG. 3 illustrates a block diagram of an exemplary wireless communications system 300 in accordance with another embodiment of the invention. The wireless communications system 300 comprises a carrier network 302, and a backbone comprising a plurality of cell sites 304a-g and 306a-f, a fiber optic ring 308, and T1 communication lines T1a-c respectively coupling cell sites 306c-e to the carrier network 302. The wireless communications system 300 provides wireless services to a plurality of SUs, such as SUs 314 and 316. As discussed above, an SU may be a mobile unit, such as a cellular and/or dispatch telephone, a laptop computer, a PDA device, a pager, and other portable devices. An SU may also be a generally stationary device, such as a desktop device or console.

The carrier network 302 may also be coupled to a PSTN 310 to allow subscribers to communicate with non-subscribers units over the PSTN 310. In addition, the carrier network 302 may be coupled to a packet switch network 312, such as the Internet, intranet, and/or local area network (LAN) to access websites and applications, and to also communicate with other subscriber and/or non-subscriber units. For example, such units accessible by way of the packet switch network 312 include a dispatch-to-desktop device.

The wireless communications system 300 not only provides wireless cell-to-cell communications to relay communications between SUs and the carrier network 302, but also provides cell-to-cell communications by way of the fiber optic ring 302 to relay communications between SUs and the carrier network 302. For instance, the wireless communications system 300 includes wireless cell sites 304a-g to relay communications between neighboring cell sites, and between SUs and neighboring cell sites by way of the wireless medium. The wireless communications system 300 also includes cell sites 306a-f to relay communications between neighboring cell sites by way of the wireless medium and the fiber optic ring, and between SUs and neighboring cell sites by way of the wireless medium. The wireless communications system 300 includes cell site 306c-e being coupled to the carrier network 302 by way of the T1 communication lines T1-c, T1-b, and T1-a, respectively. These cell sites 306c-e relay communications between SUs and the carrier network 302, between SUs and neighboring cell sites, between neighboring cell sites and the carrier network 302, and between neighboring cell sites.

The cell sites 304a-g and 306a-f of the wireless communications system 300 intelligently route communications between SUs and the carrier network 302, and vice-versa, possibly by way of more than one cell site and possibly by way of the fiber optic ring 308. The 304a-g and 306a-f may route the communications based on a number of parameters, such as the intended destination, traffic congestion, load balancing, infrastructure failure, etc.

In performing its routing algorithm, a cell site receives a radio frequency (RF) communication from an SU using any of a number of different RF protocols, such as CDMA, WCDMA, TDMA, FDMA, OFDM, and/or others. The cell site converts the RF communication to a protocol useful for routing purposes, such as IP. Then the cell site performs a routing algorithm to determine where to send the communication, such as to a neighboring cell site, a target SU, and/or the carrier network. Once the destination is known, the cell site converts the communication from IP to RF and transmits the communication to the neighboring cell site, target SU, and/or carrier network. The cell sites 306a-f, instead of converting the communication from IP to the RF protocol, can convert the communications from IP to an optics communications protocol for transmission to a neighboring cell site by way of the fiber optic ring 308.

As an example, SU 314 desires to send a communication (data, cellular voice, and/or dispatch voice) to target SU 316. According to the example, SU 314 first sends the communication to a nearby cell site 306b compliant with an RF protocol by way of the wireless medium. The cell site 306b converts the RF communication to a routing protocol (e.g. IP). Then, assuming no traffic congestion, load balancing, infrastructure failure, or other problems that may affect routing, the cell site 306b determines that the communication be routed to cell site 306c. The cell site 306b then converts the communication in the routing protocol (e.g. IP) to the appropriate optics communications protocol, and transmits the communication to cell site 306c by way of the fiber optic ring 308.

After receiving the communication, the cell site 306c converts the communication in the optics communication protocol to a routing protocol (e.g. IP), and determines where to route the communication. In this example, the cell site 306c determines to route the communication to the carrier network 302. The cell site 306c then sends the communication to the carrier network 302 by way of communication line T1-c. The carrier network 302 then determines where to route the communication. In this example, the carrier network 302 sends the communication to cell site 306e by way of communication line T1-a. Similarly, the cell site 306e determines where to route the communication. In this example, the cell site 306e determines that the communication is to be routed to cell site 304e. The cell site 306e then converts it to RF protocol for transmission to cell site 304e by way of the wireless medium.

Once cell site 304e receives the RF communication, it converts the RF communication to a routing protocol (e.g. IP). In this example, the cell site 304e determines that the communication is to be routed to SU 316. The cell site 304e converts the communication back to RF protocol, and transmits the RF communication to SU 316 by way of the wireless medium, and locks a transmit and receive link to the original destination and vice versa. A communication from SU 316 back to SU 314 may take a similar path except in the opposite direction. The communications need not be sent along the path described above, but may be sent by way of a number of different paths using cell-to-cell communications.

Again, an advantage of the wireless communications system 300 over the prior system 100 is that, because the system 300 provides for direct cell-to-cell communications to route communications to intended destinations, the system 300 may have substantially less T1 communication lines. Thus, by substantially reducing the number of T1 communication lines required for a wireless communication system, a wireless carrier operating such system could lower its operating costs substantially.

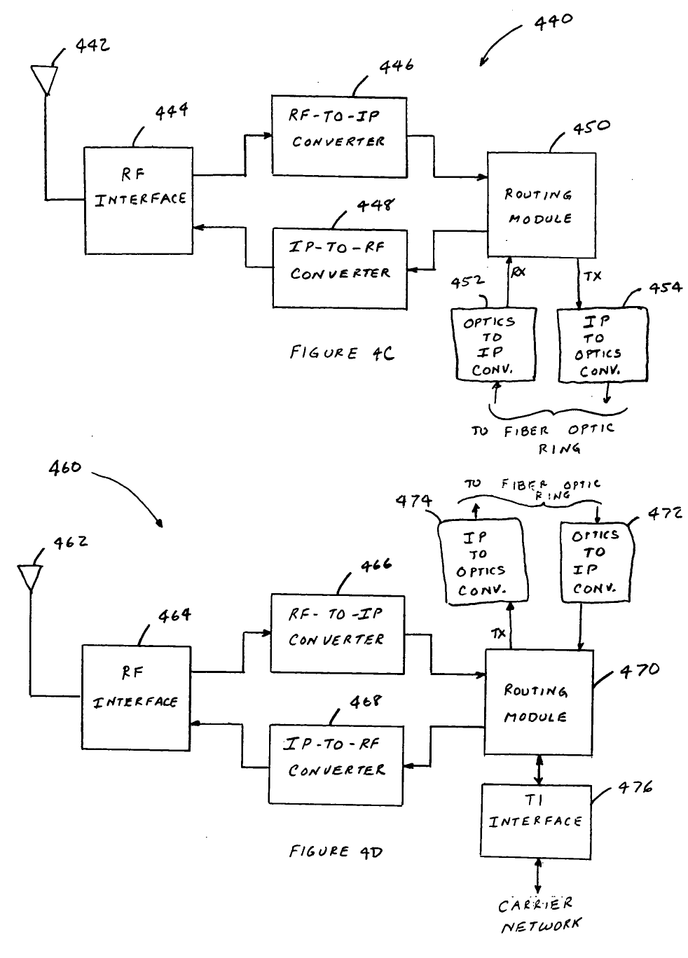

FIG. 4A illustrates a block diagram of an exemplary cell site 400 in accordance with another embodiment of the invention. The cell site 400 may be of the “wireless” type used in wireless communications system 200 and 300, such as cell sites 204a, 204c, 204d, 204f, and 204g of wireless communications system 200 and cell sites 304a-g of wireless communications system 300. The cell site 400 comprises an antenna 402, an RF interface 404, an RF-to-IP converter 406, an IP-to-RF converter 408, and a routing module 410.

The RF interface 404 including the antenna 402 provides an interface to the wireless medium for receiving communications therefrom and transmitting communications thereto in any of a number of RF protocols, including CDMA, WCDMA, TDMA, FDMA, OFDM, and/or others. The RF-to-IP converter 406 converts the received communications from RF protocol to IP protocol. The routing module 410 determines where to route the communication based on a number of factors, such as the intended destination, traffic congestion, load balancing, infrastructure failure, etc. The IP-to-RF converter 408 converts the communications from IP protocol to RF protocol for transmission by way of the wireless medium.

In operation, the RF interface 404, by way of the antenna 402, receives an RF communication from a neighboring cell site or SU in the suitable RF protocol. The RF-to-IP converter 406 converts the received communication from the suitable RF protocol to an IP protocol. The routing module 410 determines where to route the communication. Once it has determined where to route the communication, it modifies the communication to include the new routing information. The IP-to-RF converter 408 converts the modified communication from the IP protocol to the RF protocol. And finally, the RF interface 404, by way of the antenna 402, transmits the communication to a neighboring cell site or SU according to the new routing information. The operations of some or all of these elements of the cell site 400 may be assisted by a processor under the control of one or more software modules stored generally in a computer readable medium.

FIG. 4B illustrates a block diagram of an exemplary cell site 420 in accordance with another embodiment of the invention. The cell site 420 may be of the type coupled to a T1 communication line as used in wireless communications system 200, such as cell sites 204b and 204e. Similar to cell site 400, the cell site 420 comprises an antenna 422, an RF interface 424, an RF-to-IP converter 426, an IP-to-RF converter 428, and a routing module 430. Additionally, the cell site 420 includes a T1 interface 432 coupled to a T1 communication line to receive communications from and transmit communications to a carrier network.

In operation, the RF interface 424, by way of the antenna 422, receives an RF communication from a neighboring cell site or SU in the suitable RF protocol. The RF-to-IP converter 426 converts the received communication from the suitable RF protocol to an IP protocol. The routing module 430 determines where to route the communication. The routing module 430 may determine to route the communication to the carrier network by way of the T1 interface 432. In such a case, the routing modules modifies the communication to include the new routing information. Then, the routing module 430 sends the modified communication to the T1 interface 432 for transmission to the carrier network.

On the other hand, or in addition to, the routing module 430 may determine to route the communication to a neighboring cell site or SU. In such a case, the routing module modifies the communication to include the new routing information. The routing module 430 then sends the modified communication to the IP-to-RF converter 428, which converts the modified communication from the IP protocol to the RF protocol. Finally, the RF interface 424, by way of the antenna 422, transmits the communication to a neighboring cell site and/or SU according to the new routing information.

The cell site 420 may also receive communications from the carrier network. In such a case, the routing module 430 receives the communication from the carrier network by way of the T1 interface 432. The routing module 430 then determines where to route the communication. It then modifies the communication to include the new routing information. The routing module 430 then sends the modified communication to the IP-to-RF converter 428, which converts the modified communication from the IP protocol to the RF protocol. Finally, the RF interface 424, by way of the antenna 422, transmits the communication to a neighboring cell site and/or SU according to the new routing information. The operations of some or all of these elements of the cell site 420 may be assisted by a processor under the control of one or more software modules stored generally in a computer readable medium.

FIG. 4C illustrates a block diagram of an exemplary cell site 440 in accordance with another embodiment of the invention. The cell site 440 may be of the type coupled to a fiber optic ring as used in wireless communications system 300, such as cell sites 306a, 306b, and 306f. Similar to cell site 400, the cell site 440 comprises an antenna 442, an RF interface 444, an RF-to-IP converter 446, an IP-to-RF converter 448, and a routing module 450. Additionally, the cell site 440 includes an IP-to-optics converter 454 to convert communications from the IP protocol to a suitable optics communications protocol for transmission by way of a fiber optic ring. Also, the cell site 440 includes an optics-to-IP converter 452 to convert communications received from the fiber optic ring from a suitable optics communications protocol to IP protocol.

In operation, the RF interface 444, by way of the antenna 442, receives an RF communication from a neighboring cell site or SU in the suitable RF protocol. The RF-to-IP converter 446 converts the received communication from the suitable RF protocol to an IP protocol. The routing module 450 determines where to route the communication. The routing module 450 may determine to route the communication to a neighboring cell site by way the fiber optic ring. In such a case, the routing module 450 modifies the communication to include the new routing information. Then, the routing module 450 sends the modified communication to the IP-to-optics converter 454 for transmission to the neighboring cell site by way of the fiber optic ring.

On the other hand, or in addition to, the routing module 450 may determine to route the communication to a neighboring cell site or SU by way of the wireless medium. In such a case, the routing module 450 modifies the communication to include the new routing information. The routing module 450 then sends the modified communication to the IP-to-RF converter 448, which converts the modified communication from the IP protocol to the RF protocol. Finally, the RF interface 444, by way of the antenna 442, transmits the communication to a neighboring cell site and/or SU according to the new routing information.

The cell site 440 may also receive communications from neighboring cell sites by way of the fiber optic ring. In such a case, the routing module 450 receives the communication from the optics-to-IP converter 452, which converts the received communication from the suitable optics communications protocol to the IP protocol. The routing module 450 then determines where to route the communication. It then modifies the communication to include the new routing information. The routing module 450 then sends the modified communication to the IP-to-RF converter 448, which converts the modified communication from the IP protocol to the RF protocol. Finally, the RF interface 444, by way of the antenna 442, transmits the communication to a neighboring cell site and/or SU according to the new routing information. The operations of some or all of these elements of the cell site 440 may be assisted by a processor under the control of one or more software modules stored generally in a computer readable medium.

FIG. 4D illustrates a block diagram of an exemplary cell site 460 in accordance with another embodiment of the invention. The cell site 460 may be of the type coupled to a fiber optic ring and a T1 communication line as used in wireless communications system 300, such as cell sites 306c-e. Similar to cell site 400, the cell site 460 comprises an antenna 462, an RF interface 464, an RF-to-IP converter 466, an IP-to-RF converter 468, and a routing module 470. Additionally, the cell site 460 includes a T1 interface 476 coupled to a T1 communication line to receive communications from and transmit communications to a carrier network. Further, the cell site 460 includes an IP-to-optics converter 474 to convert communications from the IP protocol to a suitable optics communications protocol for transmission by way of a fiber optic ring. And, the cell site 460 includes an optics-to-IP converter 472 to convert communications received from the fiber optic ring from a suitable optics communications protocol to IP protocol.

Similar to the operations of cell sites 400, 420, and 440, cell site 460 may receive communications by way of the RF interface 464 to be routed to SUs and neighboring cell sites via the same RF interface 464. The cell site 460 may also receive communications by way of the RF interface 464 for transmission to the carrier network by way of the T1 interface 476. In addition, the cell site 460 may also receive communications by way of the RF interface 464 to be routed to a neighboring cell site by way of the IP-to-optics converter 474.

Similarly, the cell site 460 may receive communications by way of the T1 interface 476 to be routed to SUs and neighboring cell sites via the RF interface 464. The cell site 460 may also receive communications by way of the T1 interface 476 to be routed to a neighboring cell site by way of the IP-to-optics converter 474.

Similarly, the cell site 460 may receive communications by way of the optics-to-RF converter 472 to be routed to SUs and neighboring cell sites via the RF interface 464. The cell site 460 may also receive communications by way of the optics-to-RF converter 472 for transmission to the carrier network by way of the T1 interface 476. In addition, the cell site 460 may also receive communications by way of the optics-to-RF converter 472 to be routed to a neighboring cell site by way of the IP-to-optics converter 474.

In each of the cases described above, the routing module 470 determines where to route the communications based on the factors discussed above. The converters and interface ensures the communications are sent and received in the appropriate protocol by way of the corresponding medium. The operations of some or all of these elements of the cell site 470 may assisted by a processor under the control of one or more software modules stored generally in a computer readable medium.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A wireless communications system, comprising:
a carrier network; and
a backbone comprising:
one or more first-type cell sites coupled to said carrier network; and
one or more second-type cell sites adapted to transmit communications to and receive communications from said carrier network by way of said one or more first-type cell sites and a wireless medium.

2. The wireless communications system of claim 1, wherein said one or more first-type cell sites are coupled to said carrier network by way of a T1 communication line.

3. The wireless communications system of claim 1, wherein said one or more second-type cell sites area adapted to transmit communications to and receives communications from said one or more first-type cell sites by way of said wireless medium using a radio frequency (RF) protocol.

4. The wireless communications system of claim 3, wherein said RF protocol includes a code division multiple access (CDMA) protocol.

5. The wireless communications system of claim 3, wherein said RF protocol includes a wideband CDMA protocol.

6. The wireless communications system of claim 3, wherein said RF protocol includes a time division multiple access (TDMA) protocol.

7. The wireless communications system of claim 3, wherein said RF protocol includes a frequency division multiplexing (FDM) protocol.

8. The wireless communications system of claim 3, wherein said RF protocol includes an orthogonal frequency division multiplexing (OFDM) protocol.

9. The wireless communications system of claim 1, wherein said one or more first-type cell sites are adapted to transmit communications to and receive communications from a plurality of subscriber units by way of said wireless medium.

10. The wireless communications system of claim 1, wherein said one or more second-type cell sites are adapted to transmit communications to and receive communications from a plurality of subscriber units by way of said wireless medium.

11. The wireless communications system of claim 1, wherein said one or more second-type cell sites are adapted to transmit communications to and receive communications from another one or more second-type cell sites by way of said wireless medium.

12. The wireless communications system of claim 1, wherein said one or more second-type cell sites are adapted to:
receive a communication in an RF protocol by way of said wireless medium;
convert said communication in said RF protocol to a routing protocol;
determine routing information for said communication;
modify said communication to include said routing information;
convert said modified communication to said RF protocol; and
transmit said modified communication in said RF protocol by way of said wireless medium.

13. The wireless communications system of claim 12, wherein said routing protocol comprises an Internet protocol.

14. The wireless communications system of claim 1, wherein said one or more first-type cell sites are adapted to:
receive a communication from said carrier network;
determine routing information for said communication;
modify said communication to include said routing information;
convert said modified communication to said RF protocol; and
transmit said modified communication in said RF protocol by way of said wireless medium.

15. The wireless communications system of claim 1, wherein said one or more first-type cell sites are adapted to:
receive a communication in an RF protocol by way of said wireless medium;
convert said communication in said RF protocol to a routing protocol;
modify said communication to include said routing information; and
transmit said modified communication protocol to said carrier network.

16. The wireless communications system of claim 1, wherein said one or more second-type cell sites are coupled to a fiber optic medium.

17. The wireless communications system of claim 16, wherein said one or more second-type cell sites are adapted to:
receive a communication in an RF protocol by way of said wireless medium;
convert said communications in said RF protocol to a routing protocol;
determine routing information for said communication;
modify said communication to include said routing information;
convert said modified communication to an optics communications protocol; and
transmit said modified communication in said optics communications protocol by way of said fiber optic medium.

18. The wireless communications system of claim 16, wherein said one or more second-type cell sites are adapted to:
receive a communication in an optics communications protocol by way of said fiber optic medium;
convert said communications in said optics communications protocol to a routing protocol;
determine routing information for said communication;
modify said communication to include said routing information;
convert said modified communication to an RF protocol; and
transmit said modified communication in said RF protocol by way of said wireless medium.

19. The wireless communications system of claim 16, wherein said one or more second-type cell sites are adapted to:
receive a communication in an optics communications protocol by way of said fiber optic medium;
convert said communications in said optics communications protocol to a routing protocol;
determine routing information for said communication;
modify said communication to include said routing information;
convert said modified communication to said optics communications protocol; and
transmit said modified communication in said optics communications protocol by way of said fiber optic medium.

20. The wireless communications system of claim 1, wherein said carrier network is coupled to a public switch telephone network (PSTN).

21. The wireless communications system of claim 1, wherein said carrier network is coupled to a packet switch network.

22. A method of routing a communication from a source unit to a target unit comprising:
receiving, by a first cell site, said communication from said source unit by way of a wireless medium;
transmitting said communication from said first cell site to a second cell site by way of said wireless medium;
transmitting said communication from said second cell site to a carrier network; and
transmitting said communication from said carrier network to said target unit.

23. The method of claim 22, wherein transmitting said communication from said first cell site to a second cell site comprises transmitting said communication by way of one or more additional cell sites.

24. The method of claim 22, wherein transmitting said communication from said second cell site to said carrier network comprises transmitting said communication by way of a T1 communication line.

25. The method of claim 22, wherein transmitting said communication from said carrier network to said target unit comprises transmitting said communication by way of one or more additional cell sites.

26. The method of claim 22, wherein transmitting said communication from said carrier network to said target unit comprises transmitting said communication by way of a T1 communication line.

27. The method of claim 22, wherein transmitting said communication from said carrier network to said target unit comprises transmitting said communication by way of a public switch telephone network (PSTN).

28. The method of claim 22, wherein transmitting said communication from said carrier network to said target unit comprises transmitting said communication by way of a packet switch network.

29. The method of claim 22, wherein transmitting said communication from said first cell site to said second cell site comprises transmitting said communications by way of a fiber optic medium.

30. A method of routing a communication from a source unit to a target unit comprising:
receiving, by a carrier network, said communication from said source unit;
transmitting said communication from said carrier network to a first cell site;
transmitting said communication from said first cell site to a second cell site by way of a wireless medium; and
transmitting said communication from said second cell site to said target unit by way of said wireless medium.

31. The method of claim 30, wherein receiving, by said carrier network, said communication from said source unit comprises receiving said communication by way of a public switch telephone network (PSTN).

32. The method of claim 30, wherein receiving, by said carrier network, said communication from said source unit comprises receiving said communication by way of a packet switch network.

33. The method of claim 30, wherein transmitting said communication from said carrier network to said first cell site comprises transmitting said communication by way of a T1 communication line.

34. The method of claim 30, wherein transmitting said communication from said first cell site to said second cell site comprises transmitting said communication by way of one or more additional cell sites.

35. The method of claim 30, wherein transmitting said communication from said first cell site to said second cell site comprises transmitting said communication by way of a fiber optic medium.

36. A cell site comprising:
a radio frequency (RF) interface;
a first converter to convert a communication in an RF protocol received from said RF interface to a routing protocol;
a routing module to determine routing information for said communication, and to modify said communication to include said routing information; and
a second converter to convert said modified communication from said routing protocol to said RF protocol, and send said modified communication in said RF protocol to said RF interface for transmission by way of said wireless medium.

37. The cell site of claim 36, wherein said routing protocol includes an internet protocol.

38. The cell site of claim 36, further comprising an optic communications interface for receiving communications from and transmitting communications to a fiber optic medium.

39. The cell site of claim 36, further comprising a T1 interface for receiving communications from and transmitting communications to a T1 communication line.

40. A method of routing a communication, comprising:
receiving a communication in a radio frequency (RF) protocol by way of a wireless medium;
converting said communication from said RF protocol to a routing protocol;
determining routing information for said communication;
modifying said communication to include said routing information;
converting said modified communication to said RF protocol; and
transmitting said modified communication by way of said wire medium.

41. The method of claim 40, wherein said routing protocol includes an internet protocol.

42. The method of claim 40, further comprising receiving communications from and transmitting communications to a fiber optic medium.

43. The method of claim 40, further receiving communications from and transmitting communications to a T1 communication line.

44. A computer readable medium including one or more software modules to assist a cell site to:
receive a communication in a radio frequency (RF) protocol by way of a wireless medium;
convert said communication from said RF protocol to a routing protocol;
determine routing information for route said communication;
modify said communication to include said routing information;
convert said modified communication to said RF protocol; and
transmit said modified communication by way of said wire medium.

45. The computer readable medium of claim 44, wherein said routing protocol comprises an internet protocol.

46. The computer readable medium of claim 44, wherein said one or more modules are adapted to assist said cell site to receive communications from and transmit communications to a fiber optic medium.

47. The computer readable medium of claim 44, wherein said one or more modules are adapted to assist a cell site to receive communications from and transmit communications to a T1 communication line.
